(19) United States
(12) Patent Application Publication
(10) Pub. No.: US 2025/0147770 A1
(43) Pub. Date: May 8, 2025

(54) PLATFORM-LEVEL TAGGING OF OBJECTS FOR ACCESSIBILITY

(71) Applicant: Sony Interactive Entertainment Inc., Tokyo (JP)

(72) Inventors: Steven Osman, San Francisco, CA (US); John Sweeney, Alameda, CA (US)

(21) Appl. No.: 18/503,928

(22) Filed: Nov. 7, 2023

(51) Int. Cl. G06F 9/44; A63F 13/23; A63F 13/50; G10L 13/00

(52) U.S. Cl. CPC G06F 9/44; A63F 13/23; A63F 13/50; G10L 13/00

(57) ABSTRACT

A method, system, and computer readable medium for enhancing accessibility for an application, comprising associating a feature with a tag and associating the tag with an action. When the feature associated with the tag is detected triggering a device to implement the action based on the detected tag.

### FIELD OF THE DISCLOSURE

Aspects of the present disclosure relate to providing enhanced accessibility for computer applications specifically aspects of the present disclosure relate to platform-level tagging of application features for providing accessibility enhancements.

### BACKGROUND OF THE DISCLOSURE

Current computer applications such as video games have many accessibility features which may improve the experience for users that have a disability. For example, some applications include subtitles, text to speech options, or alternative color pallets to improve the experience for users that have a handicap. Providing these enhancements to accessibility can be time consuming and costly for developers.

In a computer system, applications often run in a software layer on top of an operating system and other background services. The operating system typically has some accessibility features relevant to the operating system. Other background services also may provide their own accessibility options. The operating system and other background services are not able to interface with applications in a way that allows the provision of accessibility features. Additionally, typically the features provided by the operating system are only relevant to the operating system and do not provide enhancement for applications above a rudimentary level. Some rudimentary enhancements that operating systems provide are on screen keyboards and magnifying a portion of the screen. These types of rudimentary enhancements are not very useful for complex applications such as video games.

It is within this context that aspects of the present disclosure arise.

### BRIEF DESCRIPTION OF THE DRAWINGS

The teachings of the present disclosure can be readily understood by considering the following detailed description in conjunction with the accompanying drawings, in which:

FIG. 1 is a flow diagram showing a method for providing platform-level enhanced accessibility using tagging according to an aspect of the present disclosure.

FIG. 2 is a diagram showing devices that may be used to provide enhanced accessibility with tagging used at a platform-level according to aspects of the present disclosure.

FIG. 3A is a table depicting features being associated with tags and tags being associated with types according to aspects of the present disclosure.

FIG. 3B is a table showing types being associated with actions according to aspects of the present disclosure.

FIG. 4 is a diagram depicting an example association between a feature, a tag, and an action according to aspects of the present disclosure.

FIG. 5A is a diagram depicting an example screen shot of an implementation displaying bounding box around tagged features according to aspects of the present disclosure.

FIG. 5B is a diagram showing an example screenshot of an implementation displaying a bounding box near the edge of the screen when a tagged feature is displayed according to aspects of the present disclosure.

FIG. 6 is a diagram depicting two examples of detecting tagged features according to aspects of the present disclosure.

FIG. 7A is a diagram depicting an implementation of switching controllers based on detection of a tagged feature according to aspects of the present disclosure.

FIG. 7B is a diagram depicting an implementation of switching button mapping presets based on detection of a tagged feature according to aspects of the present disclosure.

FIG. 8 is a system diagram showing a system implementing platform-level tagging for enhanced accessibility according to aspects of the present disclosure.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, examples of embodiments of the invention described below are set forth without any loss of generality to, and without imposing limitations upon, the claimed invention.

Many applications have accessibility options that provide features that allow accommodation for users who have a disability. Users without disabilities also often find these accessibility options enhance their experience providing additional enjoyable features. These accessibility features are programmed in the application and are often limited to the capabilities of the application. Additionally operating systems offer some limited accessibility options but also have the capability for more unique options because the operating system has greater networking and interconnection options. Currently there is no way for the operating system to implement accessibility features for applications. If such a system were implemented, it would allow for greater accessibility enhancement and reduce the development time for applications as accessibility features could be added easily with only a small amount of programming.

According to aspects of the present disclosure tagging of features in applications may be used to provide additional accessibility enhancements on a platform level. For example, and without limitation, applications may include a table that associates a feature such as a game asset with a tag. Each time a render call is made to the game asset the application may push the tag to the platform level (e.g., the operating system) where the platform may translate the tag to an action through an association. The association and action may be chosen by the user so that the user knows exactly the meaning behind the action when it occurs. Features may be any element of an application that may be of interest to the user. Features may be for example and without limitation, application assets (such as models, levels, maps, pictures, sprites, animations, particle effects, textures etc.), application scripting (such as game over scripting, damage scripting, healing scripting, level start scripting, level end scripting etc.), application sound (such as music and sound effects) and application videos.

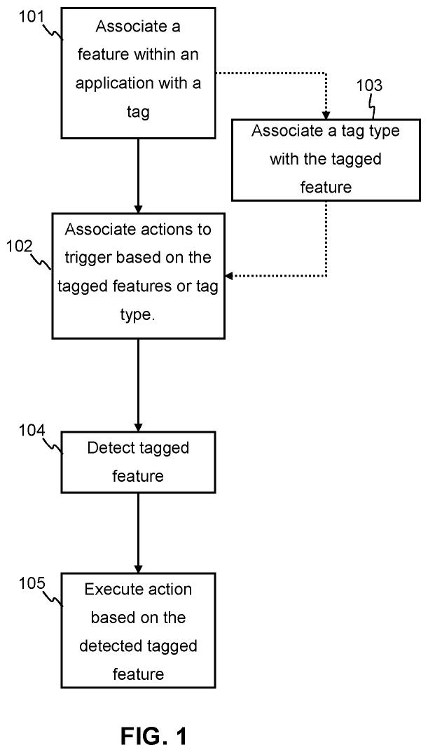

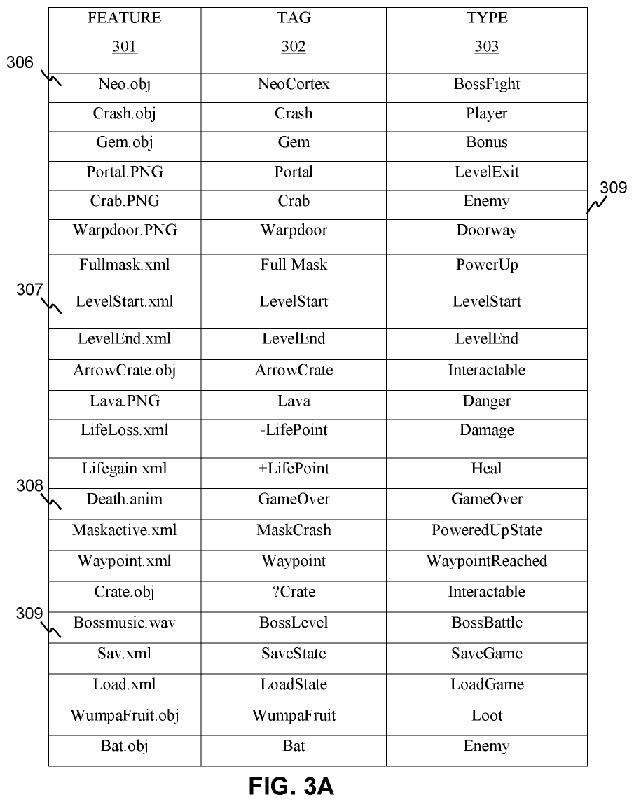

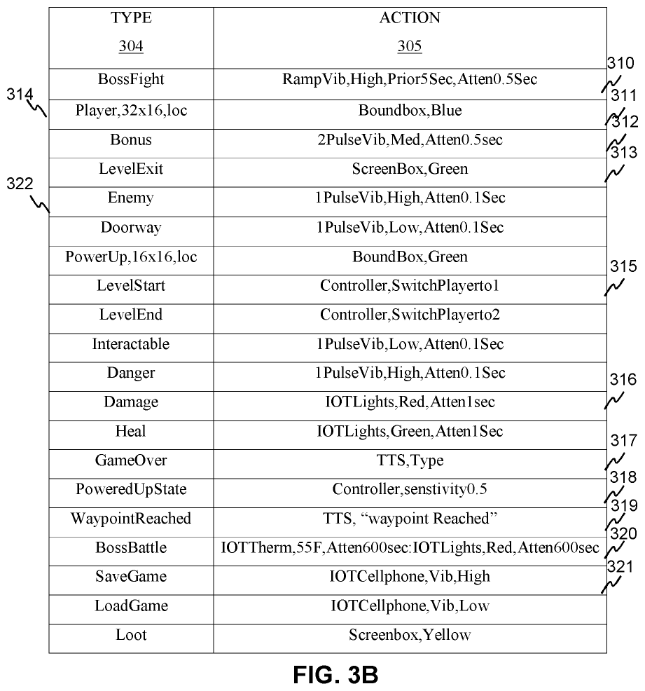

FIG. 1 is a flow diagram showing a method for providing platform-level enhanced accessibility using tagging according to an aspect of the present disclosure. As shown initially a feature is associated with a tag, as indicated at 101. The association between the tag and the feature may be handled by a table such as the one shown in FIG. 3A stored in memory or an external database. The table may include a column for the feature 301 and a column for the tag 302 thus associating the tag with the feature. The features in the implementation shown in FIG. 3 are depicted as feature files but aspects of the disclosure are not so limited, and the feature may be any element of the application that is tagged, and the tag is pushed by the application when the feature is relevant to operation of the application. Once the feature is associated with a tag, the tag may be associated with an action at 102. In some implementations, the tag may be associated with a type, as indicated at 103. The association between tag and type may be stored with a column for type 303 in the table. In this alternative implementation the tag type is associated with an action at 102. As shown in FIG. 3B, a table or other similar data structure may store a tag type 304 associated with an action 305. The actions shown here are written in a readable pseudocode describing what the system will carry out based on the type of tag pushed from the application. The addition of a tag type would allow unique tags to be pushed by the application and may provide easier development as application programmers may simply push the unique name of assets as a tag. After associations between a feature and a tag and at least a tag and an action have been created the system may use the associations to carry out actions based on the tag. Initially, while the application is running a feature may be called or drawn that triggers the tag to be pushed by the application. The platform may wait for the tag to be pushed and detect when such the tag is pushed thereby detecting the tagged feature, as indicated at 104. Alternatively, the platform may include a neural network model trained with a machine learning algorithm to detect a tagged feature and provide the tag. Once a tag is detected the associated action is determined and a device is triggered to implement the action at 105. In some alternative implementations the device may include an assistance threshold set by the developers such that the device triggers to implement the action after the threshold has been at least met. For example and without limitation, the developer or player could place an early warning sound assistance threshold for three player deaths, after a player dies three times the threshold is met and the device will trigger to implement the early warning sound when the associated tag is detected. The device may be the system itself, a network enabled device, a game controller etc. It should be understood that when platform level implementations are being discussed herein it is in reference to actions carried out by the operating system of the platform or hardware logic in the platform. While platform level implementations are discussed herein aspects of the present disclosure are not so limited and the platform level enhanced accessibility feature methods and implementations may be carried out by an accessibility program concurrently running on the system with the application or by the application itself.

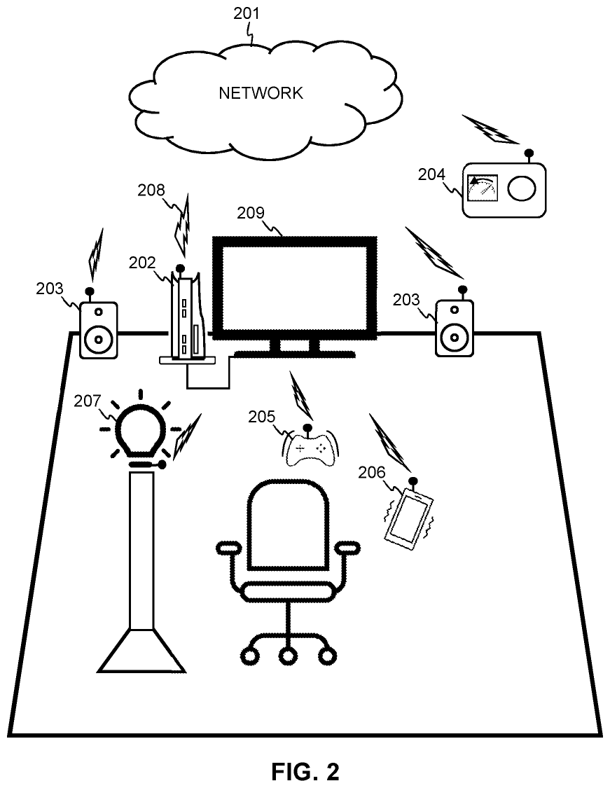

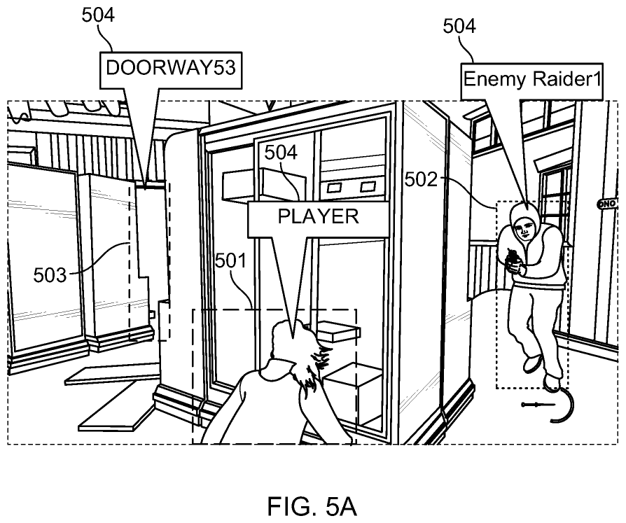

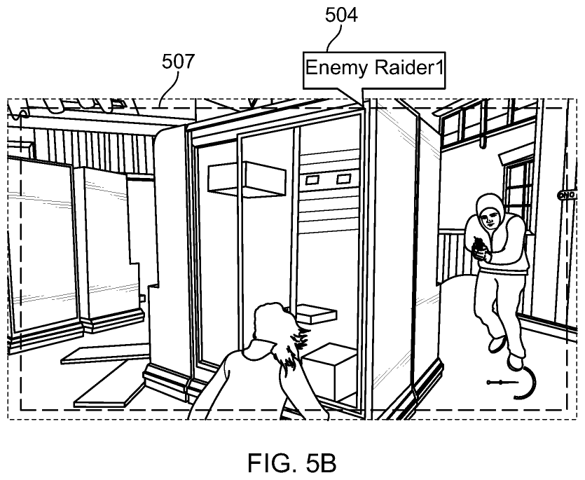

FIG. 2 is a diagram showing some examples of devices that may be used to provide enhanced accessibility with tagging used at a platform-level according to aspects of the present disclosure. As shown the system may trigger a variety of different devices to implement the determined action. The system 202 may be connected to a network 201. The network may be for example and without limitation a local area network, personal area network, wide area network, metropolitan area network, the internet etc. The network 201 communicatively couples various devices via wired or wireless connections. The system 202 may be the device that is triggered to carry out the action for example and without limitation the action may be causing a bounding box to be displayed on a connected display 209 or causing an audio wave form to be output from one or more connected speakers (not shown). As shown in FIG. 5A the bounding boxes may be displayed around different features displayed on the screen for example the action may be to display a bounding box around one or more of a player character 501, enemies 502, and a map features 503. The application may push the tag 504 for each feature and the tag may include information about the feature such as box size and location (e.g. center pixel location) on the display. Each bounding box may have a characteristic line color or line style and different tags and/or different tag types may be configured to have different colors. The colors may be selected by the user to be meaningful and/or to accommodate their disability. For example, and without limitation a person with Deuteranomaly (red-green color blindness) may choose colors that contrast each other for their vision deficit as such they may choose yellow boxes for the player, blue boxes for map elements and bright red boxes for enemies.

FIG. 5B shows an alternative, simpler implementation, having a bounding box 507 around the entire screen. This implementation may only have a tagged feature be pushed by the application as other information such as box size and center location are not necessary. This may save development time as the application programmers would not have to configure the tag with additional location and bounding box size information.

Referring again to FIG. 2, the system may trigger a device to carry out the action for example, as shown the system may communicate 208 over the network 201 with devices such as, without limitation, network enabled thermostats 204, network enabled lights sources 207, network enabled speakers 203, network enabled game controllers 205, cellular phones 206, etc. Each device may be caused by the system to perform a different action based on the detection of a tagged feature by the system. For example and without limitation, the system may send a signal to the thermostat 204 over the network 201 to trigger a change in the set point of the thermostat to a higher or lower set point than the current set point, thus, eventually causing the room to heat up or cool down. The change in temperature may enhance the experience for the player during the intense moments of the game.

In another example the system may send a signal to the network connected light source 207 triggering the light source to change from emitting a first color light to a second color light. For example and without limitation, the signal may be configured to provide a hexadecimal color code to the network connected light source and instructing the light source to change to the hexadecimal color, thus triggering the device to implement the action of changing the color of light emission.

In another example the system may send a signal to a cellular phone 206 triggering the cellular phone do one or more of, vibrate, display a message, open a web page, and open an application. Network connected speakers 203 or wire connected speakers triggered to play audio by the system for example the system may provide an audio waveform or encoded audio to the speakers.

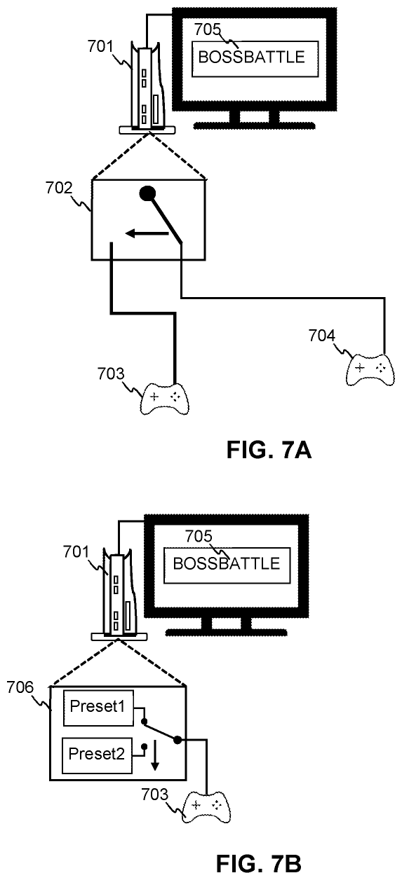

In yet another example the system may trigger a network connected controller 205 or a wired controller (not shown) to implement an action. For example and without limitation, the action may be vibration and the system may send a signal to game controller configured to cause the game controller to vibrate. The game controller may have many different vibration patterns and vibration intensity levels which may be actions customized by the user and triggered with tagged features. FIG. 7A is a diagram depicting an implementation of switching game controllers based on detection of a tagged feature according to aspects of the present disclosure. In this implementation a first game controller 703 and a second game controller 704 are connected to the system 702 may trigger to change main input of the application 702 from the second game controller 704 to the first game controller 703 (or vice versa) upon detection of the tagged feature 705. This may be implemented either by the system acting as the device and switching inputs or on the controller by disabling the second controller and enabling the first controller. In the case of a network enabled controller the system may send a signal to the second controller configured to disable the second controller and a signal to the first controller configured to enable the first controller. FIG. 7B is a diagram depicting an implementation of switching button mapping presets based on detection of a tagged feature according to aspects of the present disclosure. Here the system acting 701 as the device triggers when the tagged feature 705 is detected switching a button mapping 706 for the first game controller 703 from a first preset button mapping to a second preset button mapping.

Turning back to FIG. 3A the association between features 301, tags 302 and tag type 303 can be seen. As shown the application may be a game and features may be game assets such as models, levels maps, maps, pictures, sprites, animations, particle effects, textures etc. here assets such as a model of Neo Cortex 306 are represented as .obj model files, game scripts such as a level start script are represented as .xml data files, animations such as a death animations 308 are .anim files, and sound files such as boss music 309 are .wav files. The application may be configured to push the related tag when the feature file is called during execution of the application. The tags 302 in this implementation are taken from the name of the feature which may speed up development as the developer may not have to generate a tag for each feature. In the implementation shown, some features such as the death.anim feature 308 have tags that differ from the name of the feature and this may be so that the developer can better track what is being described by the feature.

Tag types 303 are shown in this implementation. The tag types may be used to generate actions for a type of a tag as each tag may have a unique name, but the user may want to specify an action for a general tag archetype. The type may be generated by the developer for tags or may be selected by the user. Here when a tag associated with a feature is detected the type may be provided to the platform instead of the tag itself. For example, here the feature Crab.obj has the tag Crab but provides type enemy 309 to the platform additionally the feature Bat.obj has the tag Bat and provides the type of enemy thus these two features would be handled in a related way when an action is chosen for the type of enemy. As shown in FIG. 3B there is a single entry for enemy 322 which may trigger the same action for both Crab.obj and Bat.obj features. Handling the associations in this way may reduce the load on the user to select action for many unique tags as some tag types may be shared in a logical way. It should be also noted that the information for tag and tag type may not be limited to a text string may include information such as but not limited to, location in a scene, location in a screen space, pixel location, bounding box size, feature size, feature center, occlusion, and one or more movement vector.

FIG. 3B shows the interpretation of type into an action. Here the action is represented by pseudocode describing the action. For example, here when a bossfight tag type is pushed to the platform the system causes the action of Ramp Vib, High, Prior5Sec, Atten0.5Sec 310 meaning the system will send a signal to cause a controller to ramp up vibration to high five seconds prior to the player encountering the bossfight tag type and after encountering the bossfight tag type vibration will attenuate in half a second. The platform may include some lookahead mechanisms for example and without limitation tags or tag types may be pushed to the platform by the application prior to rendering a feature on the display (e.g. the application may push a tag when a feature is cached or when a feature is stored in a rendering buffer prior to display, in a deterministic game tag types may be pushed when certain deterministic scripts or actions have been carried out but prior to display of the feature of a screen). In an example of pseudo lookahead trigger some games use some form of ‘patterns’ or ‘tells’ when game developers identify difficult areas of a specific portion of gameplay. The application may push a tag when a particular step of the pattern is identified. For example and without limitation, in the game Mike Tyson's Punchout, Mike Tyson's killer uppercut comes on step of a 10-step pattern. The tag may be pushed on step 9 of 10 to compensate and warn the player of the incoming killer uppercut. This type of pseudo look ahead provides the benefit that the application developer may choose when within the pattern to push the tag allowing the developer to customize when the player knows a particular difficult element is going to occur. In yet another example implementation of pseudo look ahead for multiplayer games the application may push a tag to the platform based on a second or other player's action, for example and without limitation, when a second Player is performing a Free Kick or Penalty Kick. This may be too difficult for Player 1, so the application may be configured to give the first player a more immediate early warning that it's a hard, low, hooking shot by pushing a tag to the platform.

Another action shown in pseudocode here is the display of a bounding box in blue, denoted here as Boundbox, Blue 311, the platform causes a bounding box centered on the feature to be displayed. The type pushed by the application may include a size and location of the feature to facilitate display of a bounding box, here the type is Player,32×16,loc 314 which means that application is pushing the type player with the feature size 32 pixels by 16 pixel and providing the current center location for the feature, loc. The action of 2PulseVib,Med,Atten0.5 sec shown at 312 may trigger a 2 pulse vibration in a game controller with medium intensity that attenuates after 0.5 seconds. The pseudocode ScreenBox, Green 313 may cause the platform to display a green box around the perimeter of the screen. Note that unlike the bounding box, here solely the tag or type is pushed for the box around the screen because screen box is not displayed around a particular feature. The action of switching application input from a first controller to a second controller is shown here with the pseudocode Controller, SwitchPlayerto1 315. The table here would trigger the device switch application to game controller one at the level start and then switch to application inputs to controller 2 when the level ends this may be used to give player 2 the illusion they are using the application when the application is really being controlled by player one this may be helpful for situations when the person using controller 2 is too young to understand use of the application but would nevertheless enjoy the illusion of using the application.

Changing the color of network enabled lights is shown in the table as the pseudocode; IOTLights, Red,Atten1 sec 316, this entry would cause the system to send a signal configured to change the network enabled lights red and then turn the lights back to their original color after 1 second in response to the pushed tag type of Damage. Text to speech may also be employed, the pseudocode here TTS, Type 317 would cause the system to send a signal to either network connected speakers or wired speakers configured to cause the speakers play text to speech sounds corresponding to the text of the associated tag type. As shown in the pseudocode TTS, “waypoint Reached” 319 would trigger the text to speech sounds of the text “waypoint reached” when the associated tag is pushed. The text to speech conversion may be generated by any suitable text to speech conversion method for example and without limitation FastSpeech, Tacotron2, wavenet, etc.

Another action may be switching controller joystick or mouse sensitivity, this may be a standalone option or included in a preset button mapping, here the pseudocode Controller,senstivity0.5 318 represents the action of changing the controller joystick sensitivity by 0.5 and is associated with the feature of the player having a power up in the application.

In the implementation shown actions may be strung together to create a compound action. Here the pseudocode IOTTherm,55F,Atten600sec: IOTLights,Red,Atten600sec 320 when triggered causes the system to send a signal to a network enabled thermostat configured to change the set point of the thermostat to 55 degrees Fahrenheit and then return to the previous setpoint after 600 seconds additionally a signal may be sent to a network enabled light source to change the color to red for 600 seconds. While in the implementation shown the pseudocode specifies the set point temperature aspects of the present disclosure are not so limited and may include commands that reduce or increase the set point temperature by a value. Similarly, while the light source emission color is specified here aspects of the present disclosure are not so limited and may include decreasing or increasing light emission intensity and/or flashing the light source. Any number of actions may be chained together to create the compound action. Additionally, a pseudocode command such as dwell may allow a compound action to be executed in linear fashion. Finally, the system may control a network connected cellphone as shown by the pseudocode IOTCellphone, Vib,High 321 which when triggered may cause the system to send a signal to be sent to a network enabled cellphone configured to cause the cellphone to vibrate at a high intensity. Thus, as shown an action table may allow different types of actions to be triggered based on a pushed type or tag.

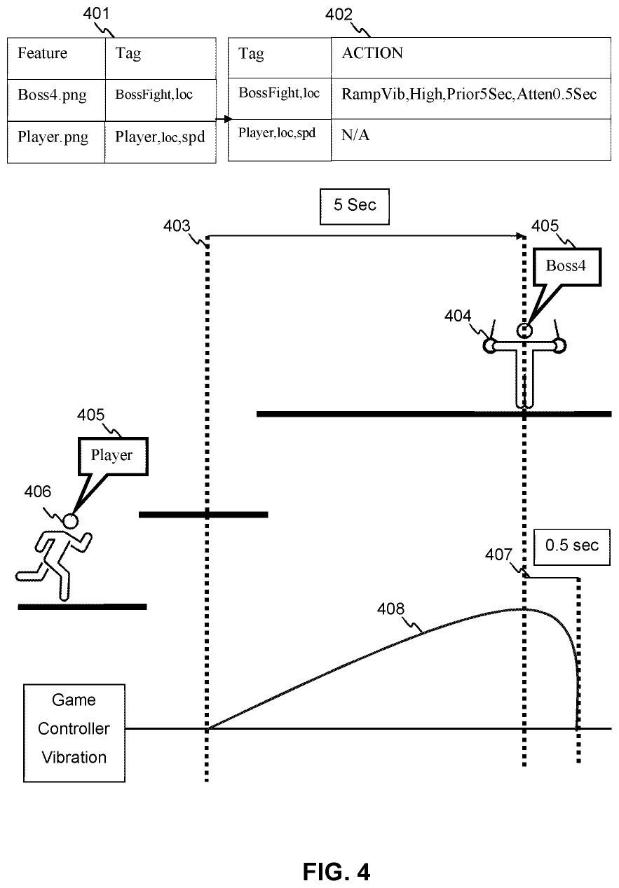

FIG. 4 is a diagram depicting an example association between a feature, a tag, and an action according to aspects of the present disclosure. Here a platformer game is shown where the player character 406 is about to encounter the boss 404. In this scene the application may push the tags 405 of player and boss4 as the player character game asset player.png 406 and the boss game asset boss4.png are being displayed on the screen. The tag table 401 may associate the game asset of boss4 with the tag BossFight. The action table 402 associates the BossFight Tag with the pseudo code command “Ramp Vib,High,Prior5Sec,Atten0.5Sec”, which triggers the game controller to ramp up vibration 408 to high, five seconds prior 403 to the player character encountering the boss4 feature. This may be calculated from information about the boss and the character. For example, and without limitation, as shown the Bossfight tag, may also include a screen space location and the player character tag may also include a player character screen space location and speed (or velocity vector), from the locations and speed a time to encounter the boss may be calculated to determine when the controller vibration should be ramped. Finally, the command attenuates the vibration 408, 0.5 second after the player character 406 encounters 407 the boss feature 404. Ramping the vibration prior to the player character encountering the boss may create a more cinematic game experience as the tension from the vibration reaches an exciting maximum when the boss is encountered. Additionally ramping of vibration may be easier to detect for persons with sensory impairments. In another example implementation a proximity zone may be centered on the boss and when the player reaches this boundary the platform may be triggered to vibrate the controller on the lowest setting; as the player moves closer to the boss controller vibration may be ramped vibrating at higher settings based on the closeness of the player to the boss. This may provide the benefit of guiding the player to the boss as the player receives vibration as feedback for proximity to the boss. In yet another example, a trigger may be based on multiple tags being present and reaching a certain threshold. The combination of these elements could help a gamer avoid going to battle and encouraging getting more health. For example and without limitation a combination of distance from boss4 (<20 m), #of enemies on screen (>4) and health (<60%) could trigger an onscreen or audible “Find Health” warning action.

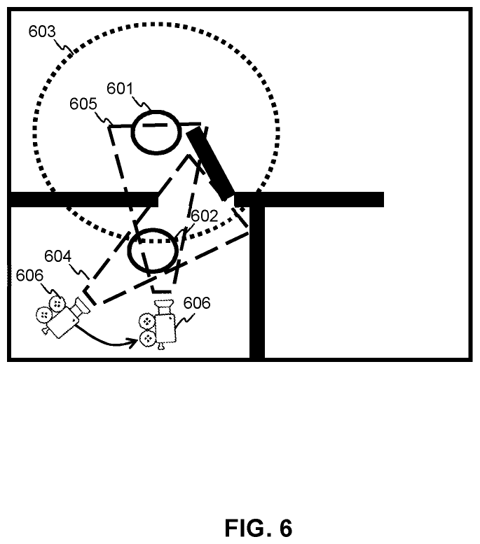

FIG. 6 is a diagram depicting two examples of detecting tagged features according to aspects of the present disclosure. In some implementations the virtual camera 606 or proximity zone 603 may be used to determine when to push a tag to the platform. In applications with a virtual camera 606 the player character 602 may be in the foreground of the camera's view 604 a tagged feature 601 may be visible to the player character but not in the current view 604 of the camera thus if the application is using camera view to determine a tag to push to the platform a tag for the tagged feature 601 would not be pushed here because the tagged feature 601 is not within view. The virtual camera 606 may move around the player character 602 to place the tagged feature 601 unobstructed in the field of view 605. The application pushes the tag of the tagged feature once when the tagged feature is in the field of view 605. In an obverse example, some games use objects (such as non-player characters) with sight lines or cones of vision, the applications in this example may push a tag when the player is within the cone of vision or line of sight of the enemy. This may be useful assistance for games with stealth mechanics where the player is notified that enemies are already alerted to their character.

Proximity based tag pushing may use a location of the tagged feature 601 relative to the location of the player character 602 to determine when to push the tag. The application may define a proximity zone 603 in the form of a circle or radius around the tagged feature 601 so that when the player character 602 enters the proximity zone the application pushes the tag. Alternatively, the application may determine the distance between the player character and the tagged feature and use the distance to determine when to push the tag.

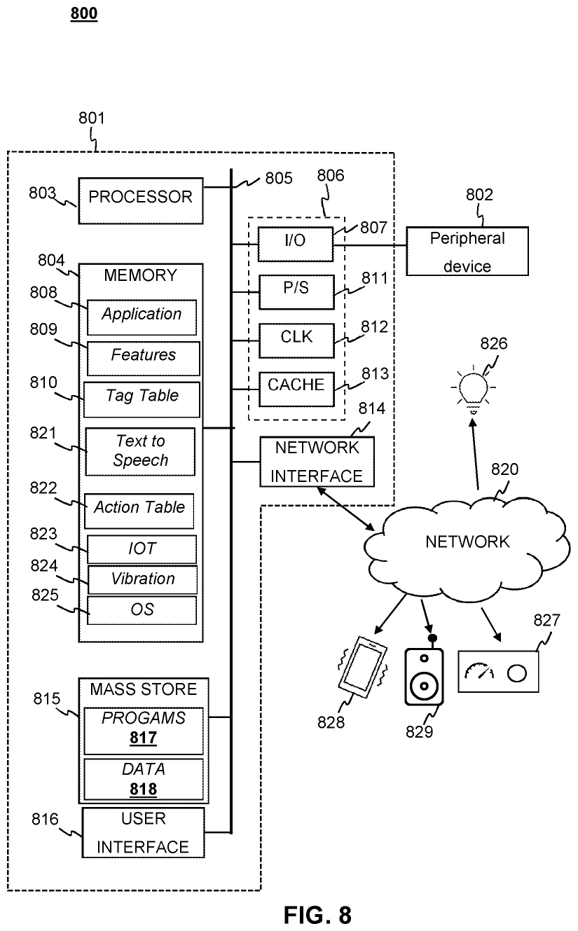

FIG. 8 depicts an example of a system 800 for implementing platform-level tagging for enhanced accessibility according to aspects of the present disclosure. The system may include a computing device 801 coupled to a user peripheral device 802. The peripheral device 802 may be a game controller, speakers, a light source, a thermostat, joystick, or other device that allows the user to feel feedback from the system.

The computing device 801 may include one or more processor units and/or one or more graphical processing units (GPU) 803, which may be configured according to well-known architectures, such as, e.g., single-core, dual-core, quad-core, multi-core, processor-coprocessor, cell processor, and the like. The computing device may also include one or more memory units 804 (e.g., random access memory (RAM), static random-access memory (SRAM), dynamic random-access memory (DRAM), read-only memory (ROM), and the like). The computing device may optionally include a mass storage device 815 such as a disk drive, CD-ROM drive, tape drive, flash memory, solid state drive (SSD) or the like, and the mass storage device may store programs and/or data.

The processor unit 803 may execute one or more programs, portions of which may be stored in memory 804 and the processor 803 may be operatively coupled to the memory, e.g., by accessing the memory via a data bus 805. The programs may be configured to implement a method for providing enhanced accessibility features as described above, for example in FIG. 1, with an application 808. These programs may be part of the platform's operating system 825 or may be standalone programs or services running independently of the application. The memory may include data utilized by the operating system or programs carrying out the method for providing enhanced accessibility features such as information corresponding to features 809 from the application, application data 818, one or more tag tables 810, e.g., as discussed above with respect to FIG. 3A, one or more action tables 822, e.g., as seen in FIG. 3B, Internet of things (IoT) networking protocols and/or programs 823, vibration pattern information 824. Additionally, the memory 804 may include one or more text to speech programs and/or models 821 for example and without limitation FastSpeech, Tacotron2, wavenet, etc. The information and/or programs stored in memory 804 may also be stored in Mass Storage 815 as programs 817 and/or data 818. Alternatively, this information may be stored on a non-transitory computer readable as instructions for the system to carry out the method for providing enhanced accessibility features, e.g., as described above with respect to FIG. 1.

The computing device 801 may also include well-known support circuits, such as input/output (I/O) 807, circuits, power supplies (P/S) 811, a clock (CLK) 812, and cache 813, which may communicate with other components of the system, e.g., via the data bus 805. The computing device may include a network interface 814 to facilitate communication with other devices. The processor 803 and network interface 814 may be configured to implement a local area network (LAN), personal area network (PAN), Wide area network (WAN), and/or communicate with the internet, via a suitable network protocol, e.g., Bluetooth, for a PAN. The computing device 801 may also include a user interface 816 to facilitate interaction between the system and a user. The user interface may include a display screen, a keyboard, a mouse, microphone, a light source and light sensor or camera, a touch interface, game controller, or other input device.

The network interface 814 facilitates communication via an electronic communications network 820. The network interface 814 may be configured to facilitate wired or wireless communication over LAN, PAN, and/or the internet to trigger actions in network connected devices. The network connected devices may include network enabled light source 826, network enabled thermostat 827, network enabled speaker 829, a cellphone 828, etc. The system 800 may send and receive data and/or commands for actions via one or more message packets over the network 820. Message packets sent over the network 820 may temporarily be stored in a buffer in memory 804. Each of the network enabled devices may have a specific protocol or application structure that is navigated to trigger the action, the instructions to navigate structures and/or protocols to induce the action in the network connected device may be stored as part of IoT 823 in the memory 804.

According to aspects of the present disclosure tagging of features in applications may be used to provide additional accessibility enhancements on a platform level. For example, and without limitation, applications may include a table that associates a feature such as a game asset with a tag. Each time a render call is made to the game asset the application may push the tag to the platform level (e.g., the operating system) where the platform may translate the tag to an action through an association, thereby providing the benefit of easy addition of new accessibility features to applications. Additionally, the data structures herein may be used with machine learning algorithms to add accessibility features to legacy applications (e.g. applications for which development has ceased) lacking such features without further programming to the existing application. This allows for accessibility options that provide features that allow accommodation for users who have a disability. Furthermore, users without disabilities may also often find that these accessibility options enhance their experience providing new enjoyable features.

While the above is a complete description of the preferred embodiment of the present invention, it is possible to use various alternatives, modifications, and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A method for enhancing accessibility for an application, comprising:
a) associating a feature with a tag;
b) associating the tag with an action;
c) detecting the feature associated with the tag;
d) triggering a device to implement the action based on the detected tag.

2. The method of claim 1 wherein a) further comprises associating the tag with a type and b) further comprises associating the type with the action.

3. The method of claim 1 wherein triggering the device to implement the action based on the detected tag includes sending a signal configured to cause a change in a color of a light source.

4. The method of claim 1 wherein triggering the device to implement the action based on the detected tag includes sending a signal configured to cause a change in a brightness of a light source.

5. The method of claim 1 wherein triggering the device to implement the action based on the tag includes sending a signal configured to vibrate a game controller.

6. The method of claim 1 wherein triggering the device to implement the action based on the tag includes sending a signal configured to cause a change in a set point of a thermostat.

7. The method of claim 1 wherein the action includes text to speech audio and triggering the device to implement the action includes playing the text to speech audio through a speaker.

8. The method of claim 1 wherein the action includes changing from a first button mapping profile to a second button mapping profile for a game controller.

9. The method of claim 8 wherein changing from the first button mapping profile to the second button mapping profile for the game controller includes changing a sensitivity of one or more of a mouse, a joystick, a thumbstick and a pressure sensitive button.

10. The method of claim 1 wherein the action includes changing application control input from a first game controller to a second game controller.

11. The method of claim 1 wherein triggering the device to implement the action based on the tag includes sending a signal configured to cause a messaging device to vibrate or display a message or both vibrate and display a message.

12. The method of claim 11 wherein the messaging device is a cellular phone.

13. The method of claim 11 wherein the messaging device is a sign board.

14. The method of claim 1 wherein the feature includes an asset from the application.

15. The method of claim 1 wherein the feature includes a map element from the application.

16. The method of claim 1 wherein the feature includes an event from the application.

17. The method of claim 1 wherein detecting the feature associated with the tag includes detecting when the feature is displayed on a screen.

18. The method of claim 1 wherein detecting the feature associated with the tag includes detecting a proximity of the feature to a detection point.

19. The method of claim 1 wherein the action includes displaying a bounding box at the perimeter of a screen.

20. The method of claim 1 wherein the action includes displaying a bounding box around the feature.

21. A system for enhancing accessibility for an application, comprising:
a processor;
a memory coupled to the processor;
non-transitory instructions in the memory that when executed by the processor cause the processor to carry out the method for enhancing accessibility for the application comprising:
a) associating a feature with a tag;
b) associating the tag with an action;
c) detecting the feature associated with the tag;
d) triggering a device to implement the action based on the detected tag.

22. The system of claim 21 wherein a) further comprises associating the tag with a type wherein b) further comprises associating the type with the action and wherein d) further comprises triggering the device to implement the action according to the type.

23. A computer readable medium having non-transitory instruction embodied thereon, the instructions when executed by a computer cause the computer to enact a method for enhancing accessibility for an application, the method comprising:
a) associating a feature with a tag;
b) associating the tag with an action;
c) detecting the feature associated with the tag;
d) triggering a device to implement the action based on the detected tag.

24. The computer readable medium of claim 23 wherein a) further comprises associating the tag with a type wherein b) further comprises associating the type with the action and wherein d) further comprises triggering the device to implement the action according to the type.
